(19) United States
(12) Patent Application Publication
(10) Pub. No.: US 2008/0219893 A1
(43) Pub. Date: Sep. 11, 2008

(54) LOCAL PLASMON ENHANCED FLUORESCENCE SENSOR

(75) Inventor: Hisashi Ohtsuka, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/042,884

(22) Filed: Mar. 5, 2008

(30) Foreign Application Priority Data
Mar. 5, 2007 (JP) 054071/2007

(51) Int. Cl. G01N 21/64

(52) U.S. Cl. 422/82.08

(57) ABSTRACT

A first substance capable of undergoing binding with a substance to be detected in a sample is fixed to a detecting section. A plurality of pieces of a second substance capable of undergoing the binding with the substance to be detected are mixed in the sample. Each of fine metal particles has been bound with one of the pieces of the second substance. A fluorescent substance has been combined with each pair of the fine metal particle and the piece of the second substance into an integral body. Exciting light capable of exciting the fluorescent substance is irradiated to the detecting section, and fluorescence produced by the fluorescent substance is detected.

### BACKGROUND OF THE INVENTION

1. Field of the Invention

This invention relates to a fluorescence sensor for detecting a specific substance, which is contained in a sample, by use of a fluorometric analysis technique. This invention particularly relates to a fluorescence sensor, in which local plasmon enhancement is utilized.

2. Description of the Related Art

Heretofore, as one of techniques for detecting pathogenic virus antigens and other proteins, there has been known an immuno-chromatographic technique as described in, for example, Japanese Patent Publication No. 7(1995)-013640. The immuno-chromatographic technique utilizes a carrier (a support), on which a substance capable of undergoing reaction and binding with a substance to be detected has been fixed at a predetermined position. Also, with the immuno-chromatographic technique, a sample, in which labeled fine particles capable of undergoing the binding with the substance to be detected have been mixed, is subjected to development on the carrier described above. In cases where the substance to be detected is present in the sample and has been bound with the substance, which has been fixed at the predetermined position on the carrier, the labeled fine particle having been bound with the substance to be detected exhibits coloration at the predetermined position on the carrier. With the immuno-chromatographic technique, the presence or absence of the substance to be detected or the quantity of the substance to be detected is detected by the utilization of the aforesaid coloration at the predetermined position on the carrier.

Recently, for example, with respect to a viral disease, such as influenza, a specific medicine, such as Tamiflu (trade name), has become available. Under the above circumstances, there is a strong demand for the immuno-chromatographic technique as a technique capable of simply and quickly detecting the pathogenic bacteria and viruses.

Ordinarily, fine gold particles are utilized as the labeled fine particles described above. In such cases, each of the fine gold particles is caused to exhibit the coloration by the utilization of absorption of light having a specific wavelength with local plasmon having occurred at a region of the fine gold particle. Therefore, with an alteration of the particle diameter of each of the fine gold particles, the color development is capable of being altered to a certain extent.

Further, heretofore, in fields of biological analyses, and the like, a fluorometric analysis technique has been used widely as an analysis technique, which has a high sensitivity. The fluorometric analysis technique is the technique, wherein exciting light having a specific wavelength is irradiated to a sample expected to contain a substance to be detected, which substance is capable of producing fluorescence by being excited by the exciting light having the specific wavelength, wherein the fluorescence having thus been produced by the substance to be detected is detected, and wherein the presence of the substance to be detected is thereby confirmed. In cases where the substance to be detected is not a fluorescent substance, a technique has heretofore been conducted widely, wherein a specific binding substance, which has been labeled with a fluorescent substance and is capable of undergoing the specific binding with the substance to be detected, is brought into contact with the sample, wherein the fluorescence is detected in the same manner as that described above, and wherein the occurrence of the specific binding, i.e. the presence of the substance to be detected, is thereby confirmed.

FIG. 2 is a schematic side view showing an example of a conventional fluorescence sensor for carrying out a fluorometric analysis technique utilizing a labeled specific binding substance. By way of example, the fluorescence sensor illustrated in FIG. 2 is utilized for detecting an antigen 2, which is contained in a sample 1. The fluorescence sensor illustrated in FIG. 2 comprises a base plate 3, on which a primary antibody 4 capable of undergoing the specific binding with the antigen 2 has been coated. The fluorescence sensor also comprises a sample support section 5, which is formed on the base plate 3. The sample 1 is caused to flow within the sample support section 5. A secondary antibody 6, which has been labeled with a fluorescent substance 10 and is capable of undergoing the specific binding with the antigen 2, is then caused to flow within the sample support section 5. Thereafter, exciting light 8 is irradiated from an exciting light source 7 toward a surface area of the base plate 3. Also, an operation for detecting the fluorescence is performed by a photodetector 9. In cases where the predetermined fluorescence is detected by the photodetector 9, the specific binding of the secondary antibody 6 and the antigen 2 with each other, i.e. the presence of the antigen 2 in the sample, is capable of being confirmed.

In the example described above, the substance whose presence is actually confirmed with the fluorescence detecting operation is the secondary antibody 6. If the secondary antibody 6 does not undergo the specific binding with the antigen 2, the secondary antibody 6 will be carried away and will not be present on the base plate 3. Therefore, in cases where the presence of the secondary antibody 6 on the base plate 3 is detected, the presence of the antigen 2, which is the substance to be detected, is capable of being confirmed indirectly.

Particularly, with the rapid advances made in enhancement of performance of photodetectors, such as the advances made in cooled CCD image sensors, in recent years, the fluorometric analysis technique described above has become the means essential for biological studies. The fluorometric analysis technique has also been used widely in fields other than the biological studies. In particular, with respect to the visible region, as in the cases of FITC (fluorescence wavelength: 525 nm, quantum yield: 0.6), Cy5 (fluorescence wavelength: 680 nm, quantum yield: 0.3), and the like, fluorescent dyes having high quantum yields exceeding 0.2, which serves as a criterion for use in practice, have been developed. It is thus expected that the fields of the application of the fluorometric analysis technique will become wide even further.

However, with the conventional fluorescence sensor as illustrated in FIG. 2, the problems are encountered in that noise is caused to occur by the reflected/scattered exciting light at an interface between the base plate 3 and the sample 1 and the light scattered by impurities/suspended materials M, and the like, other than the substance to be detected. Therefore, with the conventional fluorescence sensor, even though the performance of the photodetectors is enhanced, it is not always possible to enhance the signal-to-noise ratio in the fluorescence detecting operation.

As a technique for solving the problems described above, a fluorometric analysis technique utilizing an evanescent wave has heretofore been proposed. FIG. 3 is a schematic side view showing an example of a conventional fluorescence sensor for carrying out a fluorometric analysis technique utilizing an evanescent wave. In FIG. 3 (and in FIG. 1, which will be described later), similar elements are numbered with the same reference numerals with respect to FIG. 2. Accordingly, the explanation of the similar elements will hereinbelow be omitted.

In the fluorescence sensor illustrated in FIG. 3, in lieu of the base plate 3 described above, a prism (a dielectric material block) 13 is utilized. A metal film 20 has been formed on a surface of the prism 13. Also, the exciting light 8 having been produced by the exciting light source 7 is irradiated through the prism 13 under the conditions such that the exciting light 8 may be totally reflected from the interface between the prism 13 and the metal film 20. With the constitution of the fluorescence sensor illustrated in FIG. 3, at the time at which the exciting light 8 is totally reflected from the interface described above, an evanescent wave 11 oozes out to the region in the vicinity of the interface described above, and the secondary antibody 6 is excited by the evanescent wave 11. Also, the fluorescence detecting operation is performed by the photodetector 9 located on the side of the sample 1, which side is opposite to the side of the prism 13. (In the cases of FIG. 3, the photodetector 9 is located on the upper side.)

With the fluorescence sensor illustrated in FIG. 3, the exciting light 8 is totally reflected from the aforesaid interface downwardly in FIG. 3. Therefore, in cases where the fluorescence detecting operation is performed from above, the problems do not occur in that an exciting light detection component constitutes the background with respect to a fluorescence detection signal. Also, the evanescent wave 11 is capable of reaching only a region of several hundreds of nanometers from the aforesaid interface. Therefore, the scattering from the impurities/suspended materials M contained in the sample 1 is capable of being suppressed. Accordingly, the evanescent fluorometric analysis technique described above has attracted particular attention for serving as a technique, which is capable of markedly suppressing (light) noise than with the conventional fluorometric analysis techniques, and with which the substance to be detected is capable of being fluorometrically analyzed in units of one molecule.

The fluorescence sensor illustrated in FIG. 3 is the surface plasmon enhanced fluorescence sensor, which has the sensitivity having been enhanced markedly among the fluorescence sensors utilizing the evanescent fluorometric analysis technique. With the surface plasmon enhanced fluorescence sensor, wherein the metal film 20 is formed, at the time at which the exciting light 8 is irradiated through the prism 13, the surface plasmon arises in the metal film 20, and the fluorescence is amplified by the electric field amplifying effect of the surface plasmon. A certain simulation has revealed that the fluorescence intensity in the cases described above is amplified by a factor of approximately 1,000. The surface plasmon enhanced fluorescence sensor of the type described above is described in, for example, Japanese Patent No. 3562912 and Japanese Unexamined Patent Publication No. 10(1998)-078390.

As described above, with the immuno-chromatographic technique, the color development is capable of being altered to a certain extent with the alteration of the particle diameter of each of the labeled fine particles, such as the fine gold particles. However, since the wavelength of the absorption due to the local plasmon generated at each of the fine gold particles is equal to approximately 530 nm, the developed color is magenta, which is not much perceptible visually for persons. Therefore, the immuno-chromatographic technique described above is not always capable of meeting the requirement for high sensitivity, for example, the requirement such that a substance present in a trace amount on the order of several tens of picomols (pmol) is capable of being detected.

With the surface plasmon enhanced fluorescence sensor, it is possible to detect a substance present in a trace amount on the order of several femtomols (fmol). The surface plasmon enhanced fluorescence sensor is thus capable of meeting the requirement for high sensitivity. However, the surface plasmon enhanced fluorescence sensor, which requires a total reflection optical system, such as a prism, has the problems in that the apparatus constitution is not capable of being kept simple, and in that the cost is not capable of being kept low.

### SUMMARY OF THE INVENTION

The primary object of the present invention is to provide a fluorescence sensor, which is capable of meeting a requirement for high sensitivity, and which is capable of being kept low in cost.

The present invention provides a first local plasmon enhanced fluorescence sensor, in which electric field enhancement with local plasmon is utilized, and in which a substance to be detected is detected in the so-called sandwich mode. Specifically, the present invention provides a first local plasmon enhanced fluorescence sensor, comprising:

i) a detecting section, to which a first substance capable of undergoing binding with a substance to be detected in a sample (e.g., a liquid-state sample) has been fixed,

ii) a sample support section for supporting the sample such that the sample may come into contact with the detecting section,

iii) a plurality of pieces of a second substance, which is mixed in the sample and which is capable of undergoing the binding with the substance to be detected,

iv) a plurality of fine metal particles, each of which has been bound with one of the plurality of the pieces of the second substance,

v) a fluorescent substance, which has been combined with each pair of the fine metal particle and the piece of the second substance into an integral body,

vi) an exciting light source for irradiating exciting light, which is capable of exciting the fluorescent substance, to the detecting section, and

vii) photo detecting means for detecting fluorescence, which has been produced by the fluorescent substance having been excited by the exciting light.

The first local plasmon enhanced fluorescence sensor in accordance with the present invention should preferably be modified such that the first substance is a primary antibody, which is capable of undergoing the binding with an antigen acting as the substance to be detected, and

the second substance is a secondary antibody, which is capable of undergoing the binding with the antigen acting as the substance to be detected.

The present invention also provides a second local plasmon enhanced fluorescence sensor, in which the electric field enhancement with the local plasmon is utilized, and in which a substance to be detected is detected in the so-called competition mode. Specifically, the present invention also provides a second local plasmon enhanced fluorescence sensor, comprising:

i) a detecting section, to which a first substance capable of undergoing binding with a substance to be detected in a sample (e.g., a liquid-state sample) has been fixed,

ii) a sample support section for supporting the sample such that the sample may come into contact with the detecting section,

iii) a plurality of pieces of a second substance, which is mixed in the sample and which is capable of undergoing the binding with the first substance,

iv) a plurality of fine metal particles, each of which has been bound with one of the plurality of the pieces of the second substance,

v) a fluorescent substance, which has been combined with each pair of the fine metal particle and the piece of the second substance into an integral body,

vi) an exciting light source for irradiating exciting light, which is capable of exciting the fluorescent substance, to the detecting section, and

vii) photo detecting means for detecting fluorescence, which has been produced by the fluorescent substance having been excited by the exciting light.

The second local plasmon enhanced fluorescence sensor in accordance with the present invention should preferably be modified such that the first substance is a primary antibody, which is capable of undergoing the binding with an antigen acting as the substance to be detected, and

the second substance is a substance, which is capable of undergoing the binding with the primary antibody acting as the first substance.

Also, each of the first and second local plasmon enhanced fluorescence sensors in accordance with the present invention should preferably be modified such that each of the fine metal particles is covered with an inflexible film. Further, the fine metal particles should preferably be fine gold particles.

The first local plasmon enhanced fluorescence sensor in accordance with the present invention comprises the plurality of the pieces of the second substance, which is mixed in the sample and which is capable of undergoing the binding with the substance to be detected. The first local plasmon enhanced fluorescence sensor in accordance with the present invention also comprises the plurality of the fine metal particles, each of which has been bound with one of the plurality of the pieces of the second substance. The first local plasmon enhanced fluorescence sensor in accordance with the present invention further comprises the fluorescent substance, which has been combined with each pair of the fine metal particle and the piece of the second substance into the integral body. Therefore, with the first local plasmon enhanced fluorescence sensor in accordance with the present invention, in cases where the substance to be detected is contained in the sample and has been bound with the first substance having been fixed to the detecting section, the second substance undergoes the binding with the substance to be detected, which has been bound with the first substance on the detecting section. Specifically, in such cases, the second substance (and consequently the fine metal particles and the fluorescent substance) in the quantity corresponding to the quantity of the substance to be detected is present at the detecting section. Accordingly, at the time at which the exciting light is irradiated to the detecting section, the fluorescence is produced by the fluorescent substance. In cases where the quantity of the substance to be detected is large, the fluorescence having a high optical intensity is produced. With the detection of the optical intensity of the fluorescence performed by the photo detecting means, it is possible to perform the detection and quantitative analysis of the substance to be detected. The detection mode described above is referred to as the sandwich mode.

In the cases described above, the plurality of the fine metal particles are present at the detecting section. Therefore, the local plasmon is caused to occur by the fine metal particles, and the fluorescence is amplified with the electric field amplifying effect of the local plasmon. With the first local plasmon enhanced fluorescence sensor in accordance with the present invention, wherein the fluorescence is thus amplified, the substance to be detected is capable of being detected with a high sensitivity.

The second local plasmon enhanced fluorescence sensor in accordance with the present invention comprises the plurality of the pieces of the second substance, which is mixed in the sample and which is capable of undergoing the binding with the first substance. The second local plasmon enhanced fluorescence sensor in accordance with the present invention also comprises the plurality of the fine metal particles, each of which has been bound with one of the plurality of the pieces of the second substance. The second local plasmon enhanced fluorescence sensor in accordance with the present invention further comprises the fluorescent substance, which has been combined with each pair of the fine metal particle and the piece of the second substance into the integral body. Therefore, with the second local plasmon enhanced fluorescence sensor in accordance with the present invention, in cases where the substance to be detected is contained in the sample and has been bound with the first substance having been fixed to the detecting section, the second substance competes with the substance to be detected in binding with the first substance on the detecting section. Therefore, in such cases, the quantity of the second substance (and consequently the fine metal particles and the fluorescent substance) undergoing the binding with the first substance becomes small. Specifically, in cases where the quantity of the substance to be detected is large, the optical intensity of the fluorescence produced at the time at which the exciting light is irradiated to the detecting section, becomes low. With the detection of the optical intensity of the fluorescence performed by the photo detecting means, it is possible to perform the detection and the quantitative analysis of the substance to be detected. The detection mode described above is referred to as the competition mode.

In the cases described above, the plurality of the fine metal particles are present at the detecting section. Therefore, the local plasmon is caused to occur by the fine metal particles, and the fluorescence is amplified with the electric field amplifying effect of the local plasmon. With the second local plasmon enhanced fluorescence sensor in accordance with the present invention, wherein the fluorescence is thus amplified, the substance to be detected is capable of being detected with a high sensitivity.

Also, in each of the first and second local plasmon enhanced fluorescence sensors in accordance with the present invention, it is not necessary to utilize the total reflection optical system, such as the prism, as in the surface plasmon enhanced fluorescence sensor. Therefore, with each of the first and second local plasmon enhanced fluorescence sensors in accordance with the present invention, the apparatus constitution is capable of being kept simple, and the cost is capable of being kept low.

Further, with each of the first and second local plasmon enhanced fluorescence sensors in accordance with the present invention, wherein each of the fine metal particles is covered with the inflexible film, the problems are capable of being prevented from occurring in that the fluorescent substance is located close to the fine metal particle such that the metal quenching may occur. Therefore, in such cases, the metal quenching described above is not caused to occur. Accordingly, the electric field amplifying effect with the local plasmon is capable of being obtained reliably, and the fluorescence is capable of being detected with a markedly high sensitivity.

Furthermore, with each of the first and second local plasmon enhanced fluorescence sensors in accordance with the present invention, in cases where the inflexible film is made from a hydrophobic material, the problems do not occur in that the molecules, which will cause the quenching to occur, such as metal ions and dissolved oxygen present in the liquid-state sample, enter into the interior of the inflexible film. Therefore, the problems are capable of being prevented from occurring in that the molecules described above deprive the exciting light of the excitation energy. Accordingly, in such cases, a markedly high level of excitation energy is capable of being obtained, and the fluorescence is capable of being detected with a markedly high sensitivity.

The term “inflexible film” as used herein means the film, which has the rigidity to an extent such that the film may not be deformed to a different film thickness during the ordinary use of the sensor.

### BRIEF DESCRIPTION OF THE DRAWINGS

FIG. 1 is a schematic side view showing an embodiment of the local plasmon enhanced fluorescence sensor in accordance with the present invention,

FIG. 2 is a schematic side view showing an example of a conventional fluorescence sensor for carrying out a fluorometric analysis technique utilizing a labeled specific binding substance, and

FIG. 3 is a schematic side view showing an example of a conventional fluorescence sensor for carrying out a fluorometric analysis technique utilizing an evanescent wave.

### DESCRIPTION OF THE PREFERRED EMBODIMENTS

The present invention will hereinbelow be described in further detail with reference to the accompanying drawings.

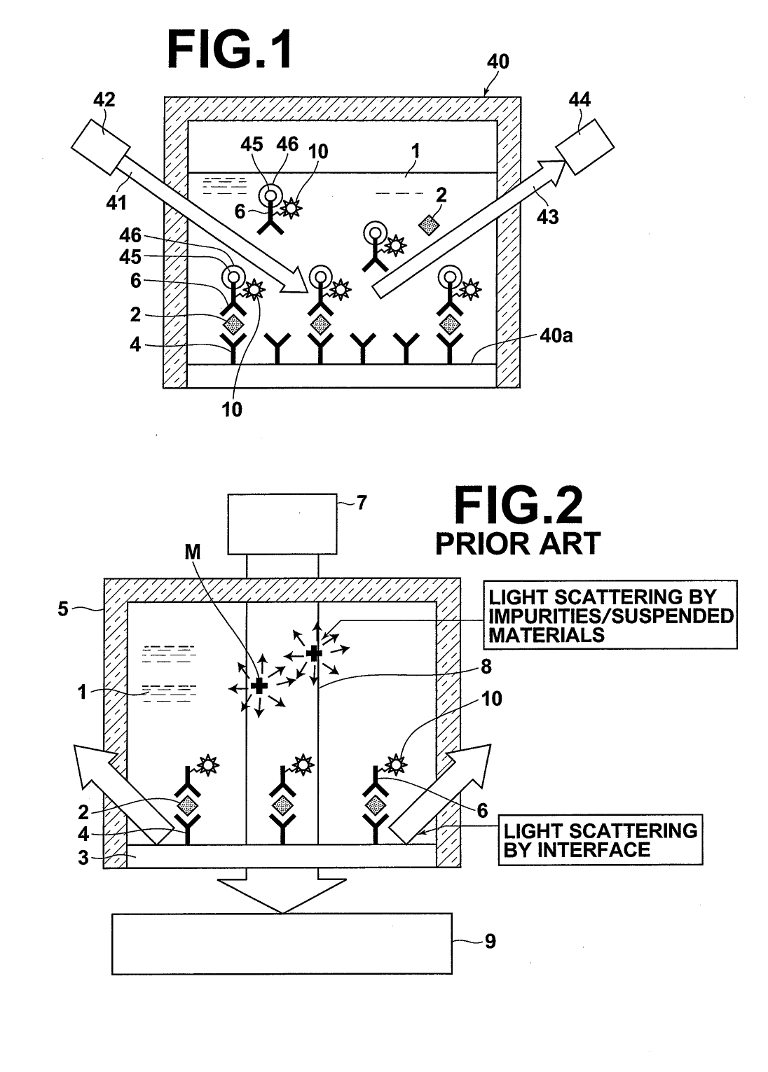

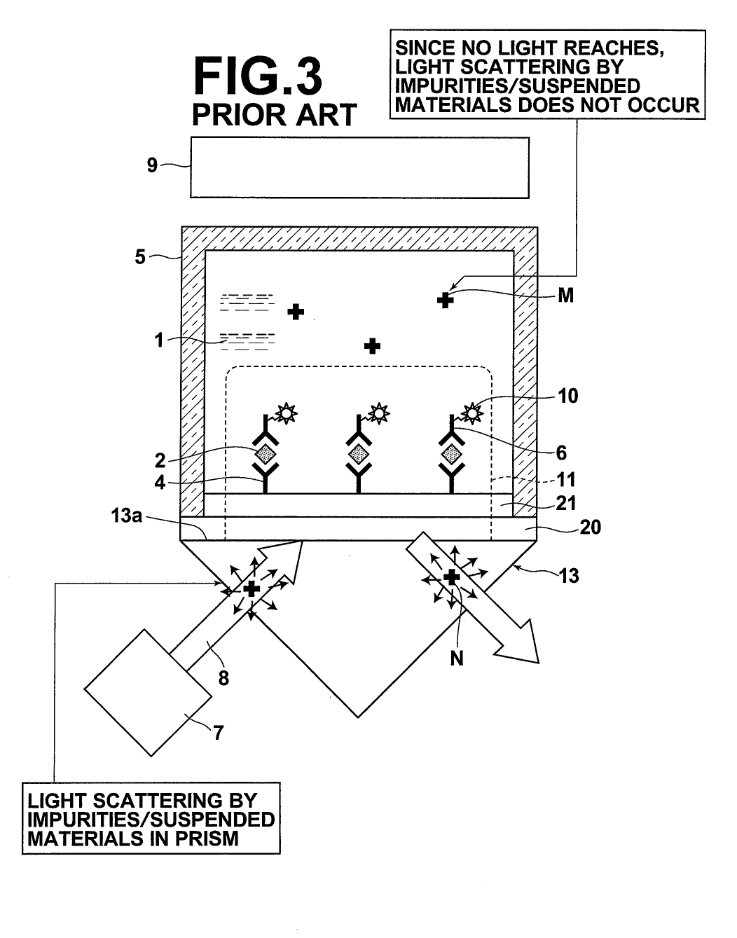

FIG. 1 is a schematic side view showing an embodiment of the local plasmon enhanced fluorescence sensor in accordance with the present invention. (The embodiment of the local plasmon enhanced fluorescence sensor in accordance with the present invention will hereinbelow be referred to simply as the fluorescence sensor.) As illustrated in FIG. 1, the fluorescence sensor comprises a sample support section 40 for supporting a sample 1, which is in the liquid state. The sample support section 40 is made from a transparent member. The fluorescence sensor also comprises an exciting light source 42, such as a semiconductor laser, for irradiating exciting light 41 toward a position on a bottom surface 40a of the sample support section 40, which bottom surface acts as the detecting section. The fluorescence sensor further comprises a photodetector 44 for detecting fluorescence 43, which comes from the bottom surface 40a of the sample support section 40 as will be described later.

By way of example, the object of the detection with the embodiment of the fluorescence sensor is a CRP antigen 2 (molecular weight: 110,000 Da). A primary antibody (a monoclonal antibody) 4, which is capable of undergoing the specific binding with the CRP antigen 2, has been fixed onto the bottom surface 40a of the sample support section 40. The primary antibody 4 has been fixed onto the bottom surface 40a of the sample support section 40 via, for example, PEG having a terminal introduced with a carboxyl group, by use of an amine coupling technique.

By way of example, the aforesaid amine coupling technique comprises the steps (1), (2), and (3) described below. The example described below is of the cases wherein a 30 μl (microliter) cuvette/cell is used.

### (1) Activation of a —COOH Group at a Linker End (Terminal)

A solution, which has been prepared by mixing 0.1 mol of NHS and 0.4 mol of EDC together in an equal volume ratio, is added in an amount of 30 μl and the resulting mixture is allowed to stand for 30 minutes at the room temperature.

NHS: N-Hydrooxysuccinimide

EDC: 1-Ethyl-3-(3-dimethylaminopropyl)carbodiimide

### (2) Fixation of the Primary Antibody 4

After washing with a PBS buffer (pH7.4) is performed five times, a primary antibody solution (500 μg/ml) is added in an amount of 30 μl, and the resulting mixture is allowed to stand for 30 to 60 minutes at the room temperature.

### (3) Blocking of an Unreacted —COOH Group

After washing with the PBS buffer (pH7.4) is performed five times, 1 mol of ethanolamine (pH8.5) is added in an amount of 30 μl, and the resulting mixture is allowed to stand for 20 minutes at the room temperature. Washing with the PBS buffer (pH7.4) is then performed five times.

At the time of the detection of the CRP antigen 2, a plurality of labeled fine metal particles are mixed into the sample 1. In this embodiment, fine gold particles (colloidal gold particles) 45, 45, . . . are employed as the fine metal particles. Also, each of a plurality of pieces of a secondary antibody 6, which is capable of undergoing the specific binding with the CRP antigen 2, has been bound with one of the fine gold particles 45, 45, . . . As the secondary antibody 6, a monoclonal antibody, which varies in epitope (antigenic determinant) from the primary antibody 4, is employed. Each of the plurality of the pieces of the secondary antibody 6 has been labeled with a fluorescent substance 10. In this embodiment, Cy3, which is capable of producing the fluorescence 43 having a peak wavelength of, for example, 575 nm when being excited by the exciting light 41 having a wavelength of, for example, 532 nm, is employed as the fluorescent substance 10.

The exciting light source 42 is not limited to the semiconductor laser described above and may be selected from the other various kinds of the known light sources. Also, as the photodetector 44, it is possible to employ, for example, LAS-1000 plus (trade name), supplied by Fuji Photo Film Co., Ltd. However, the photodetector 44 is not limited to the one described above and may be selected from the other various kinds of the known devices, such as a CCD, a PD (a photodiode), a photo multiplier, and c-MOS. Further, in cases where the excitation wavelength is altered, a fluorescent substance other than Cy3 described above is capable of being employed as a label.

The periphery of each of the fine gold particles 45, 45, is covered with an inflexible film 46. The constitution of the inflexible film 46 and how the inflexible film 46 is formed will be described in detail later.

This embodiment of the fluorescence sensor is constituted of the aforesaid elements other than the sample 1, which has the possibility of containing the CRP antigen 2. How a quantitative analysis of the CRP antigen 2, which is contained in the sample 1, is made by use of this embodiment of the fluorescence sensor in accordance with the present invention will be described hereinbelow.

Firstly, the liquid-state sample 1 is caused to flow within the sample support section 40. Thereafter, in the same manner, the labeled fine gold particles 45, 45, . . . are caused to flow within the sample support section 40. Alternatively, in lieu of the sample 1 and the labeled fine gold particles 45, 45, . . . being thus caused to flow within the sample support section 40, the liquid-state sample 1 and the labeled fine gold particles 45, 45, . . . may be stored in the sample support section 40, and the fluorescence detecting operation may be performed in this state.

Thereafter, the exciting light 41 is irradiated from the exciting light source 42 toward a position on the bottom surface 40a of the sample support section 40. At this time, in cases where the CRP antigen 2 is present in the sample 1 and has been bound with the primary antibody 4 having been fixed onto the bottom surface 40a of the sample support section 40, the secondary antibody 6 undergoes the binding with the CRP antigen 2, and the fluorescent substance 10 acting as the label of the secondary antibody 6 is excited by the exciting light 41. The fluorescent substance 10 having thus been excited by the exciting light 41 produces the fluorescence 43 having the peak wavelength of 575 nm, and the thus produced fluorescence 43 is detected by the photodetector 44. In cases where the quantity of the fluorescent substance 10 is large, i.e. in cases where the quantity of the CRP antigen 2 is large, the optical intensity of the fluorescence 43 detected in the manner described above becomes high. Therefore, the quantitative analysis of the CRP antigen 2 is capable of being made in accordance with the thus detected optical intensity of the fluorescence 43.

Also, at the time at which the exciting light 41 is irradiated from the exciting light source 42 toward the position on the bottom surface 40a of the sample support section 40 in the manner described above, the local plasmon is excited by the plurality of the fine gold particles 45, 45, . . . , which are located at the position in the vicinity of the bottom surface 40a of the sample support section 40. The fluorescence 43 is amplified with the electric field amplifying effect of the local plasmon. In cases where the fluorescence 43 is thus amplified, the CRP antigen 2 acting as the substance to be detected is capable of being detected with a high sensitivity.

Also, with this embodiment of the fluorescence sensor in accordance with the present invention, each of the plurality of the fine gold particles 45, 45, . . . is covered with the inflexible film 46. Therefore, the problems are capable of being prevented from occurring in that the fluorescent substance 10 is located close to the fine gold particle 45 such that the metal quenching may occur. Therefore, in such cases, the metal quenching described above is not caused to occur. Accordingly, the electric field amplifying effect with the local plasmon is capable of being obtained reliably, and the fluorescence 43 is capable of being detected with a markedly high sensitivity.

Further, with this embodiment of the fluorescence sensor in accordance with the present invention, it is not necessary to utilize the total reflection optical system, such as the prism, as in the surface plasmon enhanced fluorescence sensor. Therefore, with this embodiment of the fluorescence sensors in accordance with the present invention, the apparatus constitution is capable of being kept simple, and the cost is capable of being kept low.

By way of example, two techniques for forming the inflexible film 46 at the periphery of each of the fine gold particles 45, 45, . . . will be described hereinbelow. With a first technique for forming the inflexible film 46, the inflexible film 46 is formed from an SiO₂ film. The first technique for forming the inflexible film 46 approximately comprises the steps (1), (2), and (3) described below.
(1) Synthesis of colloidal gold particles acting as the fine gold particles 45, 45, . . .
(2) Replacement of a dispersant on surfaces of the colloidal gold particles (citric acid to siloxane)

An aqueous solution (2.5 ml (milliliter), 1 mmol) of APS (3-aminopropyl)trimethoxysilane) is added to 500 ml of an aqueous gold colloid solution (5×10⁻⁴ mol). The resulting mixture is strongly stirred for 15 minutes. In this manner, citric acid, which is present on the surfaces of colloidal gold particles, is subjected to replacement.
(3) Modification of the surfaces of the colloidal gold particles with SiO₂

An aqueous 0.54 wt % sodium silicate solution in a quantity of 20 ml is adjusted to a pH value of 10 to 11 and added to the aqueous gold colloid solution of the step (2). The resulting mixture is stirred strongly. When a period of time of 24 hours has elapsed, an SiO₂ film having a thickness of approximately 4 nm is formed. The resulting reaction mixture is concentrated to 30 ml with centrifugal separation. Thereafter, 170 ml of ethanol is added to the thus concentrated reaction mixture. Further, 0.6 ml of NH₄0H (28%) is added little by little to the concentrated reaction mixture, and 80 μl (microliter) of TES (tetraethoxysilane) is further added to the resulting mixture. The thus obtained mixture is slowly stirred for 24 hours. In this manner, the inflexible film 46 constituted of the SiO₂ film having a thickness of 20 nm is formed.

A second technique for forming the inflexible film 46 at the periphery of each of the fine gold particles 45, 45, . . . will be described hereinbelow. With the second technique for forming the inflexible film 46, the inflexible film 46 is formed with polymer covering. The second technique for forming the inflexible film 46 approximately comprises the steps (1) and (2) described below.
(1) Re-Dispersing of Gold Nanoparticles Acting as the Fine Gold Particles 45, 45, . . . in DMF

Firstly, 1 ml of an aqueous dispersion containing at most approximately 360 pmol (=7×10⁻¹¹ wt %) of citric acid-stabilized gold nanoparticles having a mean particle diameter of approximately 30 nm is prepared. The aqueous dispersion is then subjected to centrifugal separation, and 0.95 ml of a supernatant liquid is discarded. A remaining dark red viscous precipitate is subjected to re-dispersing in 1 ml of DMF (N,N,-dimethylformamide). Excess citric acid ions inhibit encapsulization of the particles. Also, in cases where the particles having a small particle diameter are used, washing with water should preferably be performed before the addition of DMF.
(2) Encapsulization of the Gold Nanoparticles

Thereafter, 10 μl of a DMF solution (approximately 10⁻²g/ml) of a polystyrene-polyacrylic acid block copolymer (polystyrene: a polymer formed from approximately 100 molecules of the monomer, polyacrylic acid: a polymer formed from approximately 13 molecules of the monomer) is added to 1 ml of the DMF dispersion, which has been obtained in the step (1) described above and which contains approximately 648 pmol (=7×10⁻¹¹ wt %) of the citric acid-stabilized gold nanoparticles having a mean particle diameter of approximately 30 nm. Thereafter, 200 μl of water is added to the resulting mixture at a flow rate of 8.3 μl/min by use of a syringe pump, and the thus obtained mixture is stirred violently. At the time at which the mixture is thus stirred violently for a period of time of 10 minutes, the color of the liquid alters to violet little by little. At this stage, 5 μl of a 1 wt % dodecane thiol DMF solution is added to the liquid. The thus obtained mixture is then stirred for 24 hours. Thereafter, 3 ml of water is added to the resulting mixture at a flow rate of 2 ml/h by use of the syringe pump.

Thereafter, dialysis is performed for 24 hours, and DMF is thereby removed. Also, 72 μl of an EDC solution (0.1 wt % with respect to water: 24 nmol) is added at a stretch with stirring. At the time at which the stirring has been performed for 30 minutes, 144 μl of a EDODEA solution (0.1 wt % with respect to water: 96 nmol) is added at a stretch, and the resulting mixture is stirred.

The dialysis is then performed for 24 hours, and the reagent is thereby removed. Thereafter, the centrifugal separation is performed at 4,000 G for 30 minutes, and the supernatant liquid in a quantity corresponding to 80% in terms of volume is discarded. Water in a volume identical with the volume of the supernatant liquid having been discarded is added, and the centrifugal separation is performed in the same manner as that described above. The operations ranging from the aforesaid centrifugal separation, which is followed by the discarding of the supernatant liquid, to the next centrifugal separation described above are iterated at least three times, a film constituted of a crosslinked product of the polystyrene-polyacrylic acid block copolymer is formed as the inflexible film 46 at the periphery of each of the gold nanoparticles (fine gold particles 45, 45, . . . )

With the aforesaid embodiment of the fluorescence sensor in accordance with the present invention, the fluorescence detecting operation is performed in the detection mode, which is referred to as the sandwich mode. Alternatively, in the fluorescence sensor in accordance with the present invention, the fluorescence detecting operation may be performed in the detection mode, which is referred to as the competition mode. In such cases, for example, in the constitution illustrated in FIG. 1, in lieu of the plurality of the pieces of the secondary antibody 6, a plurality of pieces of a second substance, which is capable of undergoing the binding with the primary antibody 4, are employed. Also, each of the plurality of the pieces of the second substance is bound with one of the fine gold particles 45, 45, . . . , each of which has been covered with the inflexible film 46, and the fluorescent substance 10. The plurality of the pieces of the second substance, each of which has thus been bound with one of the fine gold particles 45, 45, . . . and the fluorescent substance 10, are mixed into the sample 1. In this manner, the fluorescence sensor for performing the fluorescence detecting operation in the so-called competition mode is capable of being obtained. Specifically, in such cases, the second substance and the CRP antigen 2 compete with each other in binding with the primary antibody 4. Therefore, in cases where the quantity of the CRP antigen 2 is large, the quantity of the fluorescent substance 10 present at the detecting section becomes small, and the optical intensity of the fluorescence 43 detected at the time at which the exciting light 41 is irradiated to the detecting section, becomes low. Accordingly, with the fluorescence sensor for performing the fluorescence detecting operation in the detection mode, which is referred to as the competition mode, the quantitative analysis of the CRP antigen 2 is capable of being made in accordance with the optical intensity of the fluorescence detected.

What is claimed is:

1. A local plasmon enhanced fluorescence sensor, comprising:
i) a detecting section, to which a first substance capable of undergoing binding with a substance to be detected in a sample has been fixed,
ii) a sample support section for supporting the sample such that the sample may come into contact with the detecting section,
iii) a plurality of pieces of a second substance, which is mixed in the sample and which is capable of undergoing the binding with the substance to be detected,
iv) a plurality of fine metal particles, each of which has been bound with one of the plurality of the pieces of the second substance,
v) a fluorescent substance, which has been combined with each pair of the fine metal particle and the piece of the second substance into an integral body,
vi) an exciting light source for irradiating exciting light, which is capable of exciting the fluorescent substance, to the detecting section, and
vii) photo detecting means for detecting fluorescence, which has been produced by the fluorescent substance having been excited by the exciting light.

2. A local plasmon enhanced fluorescence sensor as defined in claim 1 wherein the first substance is a primary antibody, which is capable of undergoing the binding with an antigen acting as the substance to be detected, and
the second substance is a secondary antibody, which is capable of undergoing the binding with the antigen acting as the substance to be detected.

3. A local plasmon enhanced fluorescence sensor, comprising:
i) a detecting section, to which a first substance capable of undergoing binding with a substance to be detected in a sample has been fixed,
ii) a sample support section for supporting the sample such that the sample may come into contact with the detecting section,
iii) a plurality of pieces of a second substance, which is mixed in the sample and which is capable of undergoing the binding with the first substance,
iv) a plurality of fine metal particles, each of which has been bound with one of the plurality of the pieces of the second substance,
v) a fluorescent substance, which has been combined with each pair of the fine metal particle and the piece of the second substance into an integral body,
vi) an exciting light source for irradiating exciting light, which is capable of exciting the fluorescent substance, to the detecting section, and
vii) photo detecting means for detecting fluorescence, which has been produced by the fluorescent substance having been excited by the exciting light.

4. A local plasmon enhanced fluorescence sensor as defined in claim 3 wherein the first substance is a primary antibody, which is capable of undergoing the binding with an antigen acting as the substance to be detected, and
the second substance is a substance, which is capable of undergoing the binding with the primary antibody acting as the first substance.

5. A local plasmon enhanced fluorescence sensors as defined in claim 1 wherein each of the fine metal particles is covered with an inflexible film.

6. A local plasmon enhanced fluorescence sensors as defined in claim 2 wherein each of the fine metal particles is covered with an inflexible film.

7. A local plasmon enhanced fluorescence sensors as defined in claim 3 wherein each of the fine metal particles is covered with an inflexible film.

8. A local plasmon enhanced fluorescence sensors as defined in claim 4 wherein each of the fine metal particles is covered with an inflexible film.

9. A local plasmon enhanced fluorescence sensors as defined in claim 5 wherein the inflexible film is constituted of a polymer.

10. A local plasmon enhanced fluorescence sensors as defined in claim 6 wherein the inflexible film is constituted of a polymer.

11. A local plasmon enhanced fluorescence sensors as defined in claim 7 wherein the inflexible film is constituted of a polymer.

12. A local plasmon enhanced fluorescence sensors as defined in claim 8 wherein the inflexible film is constituted of a polymer.

13. A local plasmon enhanced fluorescence sensors as defined in claim 1 wherein the fine metal particles are fine gold particles.

14. A local plasmon enhanced fluorescence sensors as defined in claim 2 wherein the fine metal particles are fine gold particles.

15. A local plasmon enhanced fluorescence sensors as defined in claim 3 wherein the fine metal particles are fine gold particles.

16. A local plasmon enhanced fluorescence sensors as defined in claim 4 wherein the fine metal particles are fine gold particles.

17. A local plasmon enhanced fluorescence sensors as defined in claim 5 wherein the fine metal particles are fine gold particles.

18. A local plasmon enhanced fluorescence sensors as defined in claim 6 wherein the fine metal particles are fine gold particles.

19. A local plasmon enhanced fluorescence sensors as defined in claim 7 wherein the fine metal particles are fine gold particles.

20. A local plasmon enhanced fluorescence sensors as defined in claim 8 wherein the fine metal particles are fine gold particles.
